(19) United States
(12) Patent Application Publication
(10) Pub. No.: US 2022/0018428 A1
(43) Pub. Date: Jan. 20, 2022

(54) DOUBLE ROW ROLLER CAM TRANSMISSION MECHANISM WITH BACKLASH ADJUSTMENT MEANS

(71) Applicant: Chui-Tsai CHIU, Taoyuan City (TW)

(72) Inventor: Chui-Tsai CHIU, Taoyuan City (TW)

(21) Appl. No.: 17/170,605

(22) Filed: Feb. 8, 2021

(30) Foreign Application Priority Data
Jul. 15, 2020 (TW) 109123946

(51) Int. Cl. F16H 53/08; F16H 57/12

(52) U.S. Cl. CPC F16H 53/08; F16H 2057/126; F16H 57/12

(57) ABSTRACT

A backlash-free double row roller cam transmission mechanism includes two passive wheels, two sets of rollers respectively pivotally arranged on the circular peripheral edges of the passive wheels, and a transmission camshaft with two opposite sides of a spiral protrusion respectively abutted against the two sets of rollers. Use the principle of oblique wedge adjustment to generate the reverse thrust of the rollers, thereby eliminating the backlash between the rollers and the spiral protrusion. All rollers can abut against the entire spiral protrusion to increase the structural rigidity and transmission load and prolong the service life. The design is conducive to achieving the cam self-locking function.

### BACKGROUND OF THE INVENTION

### 1. Field of the Invention

The present invention relates to cam transmission technology and more particularly, to a backlash-free double row roller cam transmission mechanism, which uses two passive wheels to share one transmission camshaft and lets the rollers arranged on the two passive wheels to abut against the inner and outer surfaces of the spiral protrusion of the transmission camshaft so that the backlash between the rollers and the spiral transmission can be eliminated.

### 2. Description of the Related Art

When the cam transmission mechanism is operated at high speed, the inertia load is large, so it is easy to generate negative torque. If there is a backlash between the cam and the rollers, a knock will occur and vibration will be generated, reducing the transmission efficiency and accuracy and shortening the service life of the cam. Therefore, the relevant industry has divided the cam into two cam members that can be moved away from each other in different directions, so that the rollers on the rotating wheel respectively abut against the two cam members, thereby eliminating the backlash. However, in order to maintain the relative position of the two cam members, it is necessary to use a shaft coupling or a keyway mechanism to connect the two cam members. Due to the presence of the shaft coupling or keyway mechanism between the two cam members, adjusting the backlash becomes more difficult. Furthermore, due to the use of two cam members, the inertial load on the cm will increase and the rigidity will be weakened, resulting in the cam's life cannot be effectively extended. In addition, the overall structural design is relatively weak, and the rigidity and the transmission load that it can bear are also small, making it difficult to achieve the cam self-locking function.

### SUMMARY OF THE INVENTION

The present invention has been accomplished under the circumstances in view. It is therefore the main object of the present invention to provide a backlash-free double row roller cam transmission mechanism, which uses two passive wheels to share one transmission camshaft. The simple structure design can eliminate the backlash between the rollers set on the two passive wheels and the spiral protrusion of the transmission camshaft, thereby reducing the inertial load of the spiral protrusion, and increasing the structural rigidity and transmission load and prolonging the service life, which is more conducive to achieving many functions such as cam self-locking.

It is another object of the present invention to provide a backlash-free double row roller cam transmission mechanism, which uses two passive wheels to share one transmission cam, and has the transmission camshaft located inside between the two passive wheels, which can effectively save the overall volume space.

To achieve these and other objects of the present invention, a backlash-free double row roller cam transmission mechanism comprises a first passive wheel, a second passive wheel and a transmission camshaft. The first passive wheel comprises a first rotating wheel and a plurality of first rollers. The first rotating wheel comprises a first wheel body providing a circular periphery. The first rollers are pivotally arranged on the circular periphery of the first wheel body away from the center of the first passive wheel. The second passive wheel comprises a second rotating wheel and a plurality of second rollers. The second rotating wheel comprises a second wheel body providing a circular periphery. The second rollers are pivotally arranged on the circular periphery of the second wheel body away from the center of the second passive wheel. The transmission camshaft is connected between the first passive wheel and the second passive wheel. The transmission camshaft comprises a spiral protrusion. The spiral protrusion comprises an inner surface and an outer surface respectively located on two opposite sides thereof. The inner surface is abutted against the first rollers of the first passive wheel. The outer surface is abutted against the second rollers of the second passive wheel. When the transmission camshaft is driven, the first passive wheel and the second passive wheel are relatively pivoted, and the reverse thrust of the first rollers and the second rollers is generated by the principle of oblique wedge adjustment, thereby eliminating the backlash between the first rollers and the inner surface and the backlash between the second rollers and the outer surface.

By the specific embodiments listed below, it will be easier to understand the purpose, technical content, characteristics and effects achieved by the present invention.

### BRIEF DESCRIPTION OF THE DRAWINGS

FIG. 1 is an oblique top elevational view of a backlash-free double row roller cam transmission mechanism in accordance with a first embodiment of the present invention.

FIG. 2 is a side view of FIG. 1.

FIG. 3 is a schematic drawing illustrating the rollers abutted against the spiral protrusion after adjustment.

FIG. 4 is an oblique top elevational view of a backlash-free double row roller cam transmission mechanism in accordance with a second embodiment of the present invention.

FIG. 5 is a side view of FIG. 4.

FIG. 6 is a schematic elevational view of a backlash-free double row roller cam transmission mechanism in accordance with a third embodiment of the present invention.

FIG. 7 is a side view of FIG. 6.

FIG. 8 is a schematic elevational view of a backlash-free double row roller cam transmission mechanism in accordance with a fourth embodiment of the present invention.

FIG. 9 is a side view of FIG. 8.

FIG. 10 is a front view of FIG. 8.

FIG. 11 is a schematic elevational view of a backlash-free double row roller cam transmission mechanism in accordance with a fifth embodiment of the present invention.

FIG. 12 is a side view of FIG. 11.

FIG. 13 is a front view of FIG. 11.

### DETAILED DESCRIPTION OF THE PREFERRED EMBODIMENTS

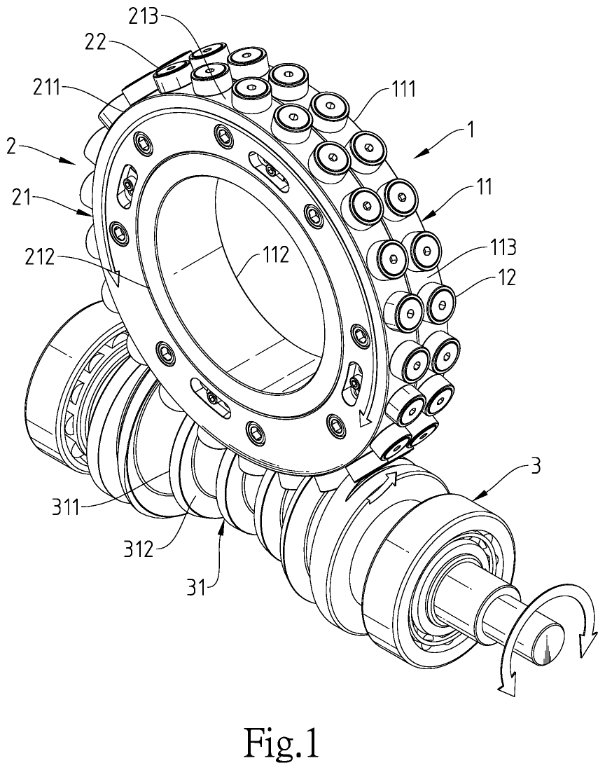

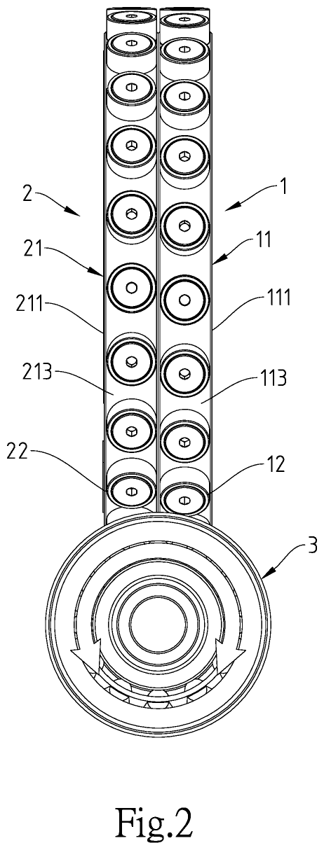

Referring to FIGS. 1-3, a backlash-free double row roller cam transmission mechanism in accordance with a first embodiment of the present invention is shown. The backlash-free double row roller cam transmission mechanism comprises a first passive wheel 1, a second passive wheel 2, and a transmission camshaft 3.

The first passive wheel 1 comprises a first rotating wheel 11 and a row of first rollers 12. The first rotating wheel 11 comprises a first wheel body 111. The first rollers 12 are pivotally arranged on the circular periphery of the first wheel body 111 away from the center.

The second passive wheel 2 comprises a second rotating wheel 21 and a row of second rollers 22. The second rotating wheel 21 comprises a second wheel body 211. The second rollers 22 are pivotally arranged on the circular periphery of the second wheel body 211 away from the center.

The transmission camshaft 3 is mounted at one side of the first passive wheel 1 and the second passive wheel 2. The transmission camshaft 3 is provided with a spiral protrusion 31, and opposing inner surface 311 and outer surface 312 are formed on both sides of the spiral protrusion 31.

In this first embodiment, the first rotating wheel 11 comprises a first shaft portion 112 protruded from one side thereof. The second rotating wheel 21 comprises a shaft hole 212. The first shaft portion 112 is pivotally connected to the shaft hole 212 so that the first passive wheel 1 and the second passive wheel 2 are connected together. The first rollers 12 are pivotally connected to a first outer peripheral edge 113 at the outer edge of the first wheel body 111. The second rollers 22 are pivotally connected to a second outer peripheral edge 213 at the outer edge of the second wheel body 211. The section of the first wheel body 111 of the first rotating wheel 11 and the section of the second wheel body 211 of the second rotating wheel 21 are parallel, so that the first rollers 12 and the second rollers 22 are arranged side by side. The inner surface 311 of the spiral protrusion 31 is abutted against the first rollers 12 of the first passive wheel 1. The outer surface 312 of the spiral protrusion 31 is abutted against the second rollers 22 of the second passive wheel 2. When the transmission camshaft 3 is driven, the first passive wheel 1 and the second passive wheel 2 can be relatively pivoted, and the reverse thrust of the first rollers 12 and the second rollers 22 is generated by the principle of oblique wedge adjustment, thereby eliminating the backlash between the first rollers 12 and the inner surface 311 and the backlash between the second rollers 22 and the outer surface 312.

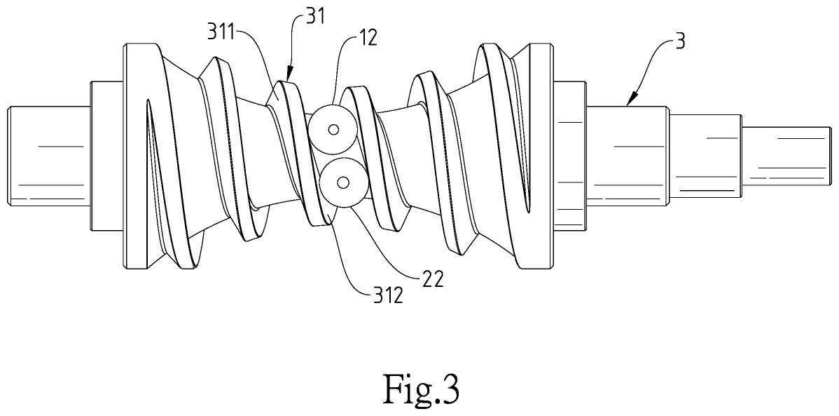

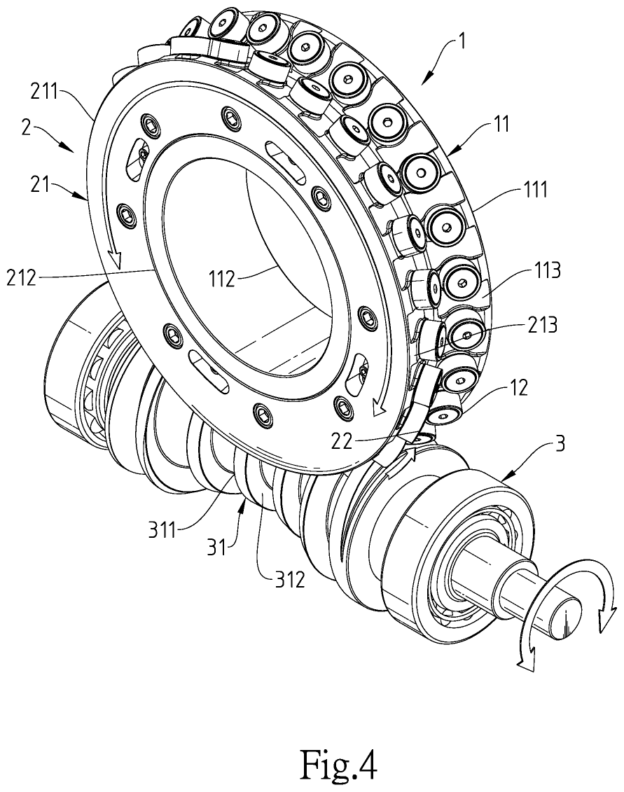

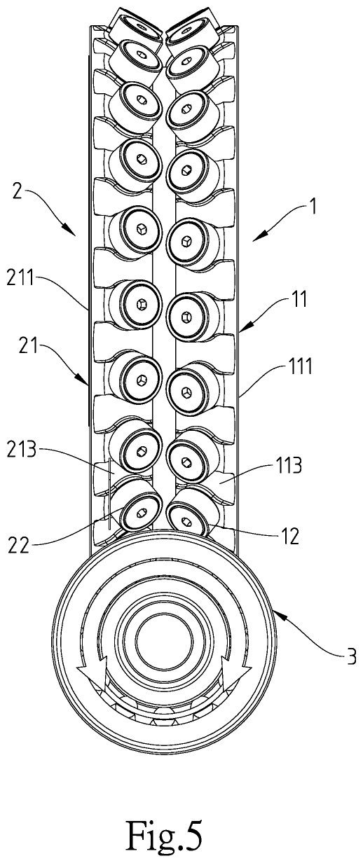

Referring to FIGS. 4 and 5, a backlash-free double row roller cam transmission mechanism in accordance with a second embodiment of the present invention is shown. The same components in the second embodiment and the first embodiment have the same reference numerals, and the same parts will not be repeated. In this second embodiment, the first rotating wheel 11 comprises a first shaft portion 112 protruded from one side thereof. The second rotating wheel 21 comprises a shaft hole 212. The first shaft portion 112 is pivotally connected to the shaft hole 212 so that the first passive wheel 1 and the second passive wheel 2 are connected together. The first rollers 12 are pivotally connected to the first outer peripheral edge 113 of the first wheel body 111. The second rollers 22 are pivotally connected to the second outer peripheral edge 213 of the second wheel body 211. An angle of less than 180 degrees is formed between the section of the first wheel body 111 of the first rotating wheel 11 and the section of the second wheel body 211 of the second rotating wheel 21, so that the row of first rollers 12 and the row second rollers 22 are set at an angle of 180 degrees. The transmission camshaft 3 is mounted at one side of the first passive wheel 1 and the second passive wheel 2. The transmission camshaft 3 is provided with a spiral protrusion 31, and opposing inner surface 311 and outer surface 312 are formed on both sides of the spiral protrusion 31. Referring also to FIG. 3, the inner surface 311 of the spiral protrusion 31 is abutted against the first rollers 12 of the first passive wheel 1. The outer surface 312 of the spiral protrusion 31 is abutted against the second rollers 22 of the second passive wheel 2. When the transmission camshaft 3 is driven, the first passive wheel 1 and the second passive wheel 2 can be relatively pivoted, and the reverse thrust of the first rollers 12 and the second rollers 22 is generated by the principle of oblique wedge adjustment. The principle of oblique wedge adjustment is the tilt operation of the first passive wheel 1 and the second passive wheel 2. The arrangement that the row of first rollers 12 and the row second rollers 22 are set at an angle of 180 degrees helps stabilize the relative position between first passive wheel 1, second passive wheel 2 and transmission camshaft 3, and can be adjusted to each other to avoid the influence of various errors in actual manufacturing and assembly, and then eliminate the backlash between the first rollers 12 and the inner surface 311 and the backlash between the second rollers 22 and the outer surface 312, thereby achieving the most ideal line contact.

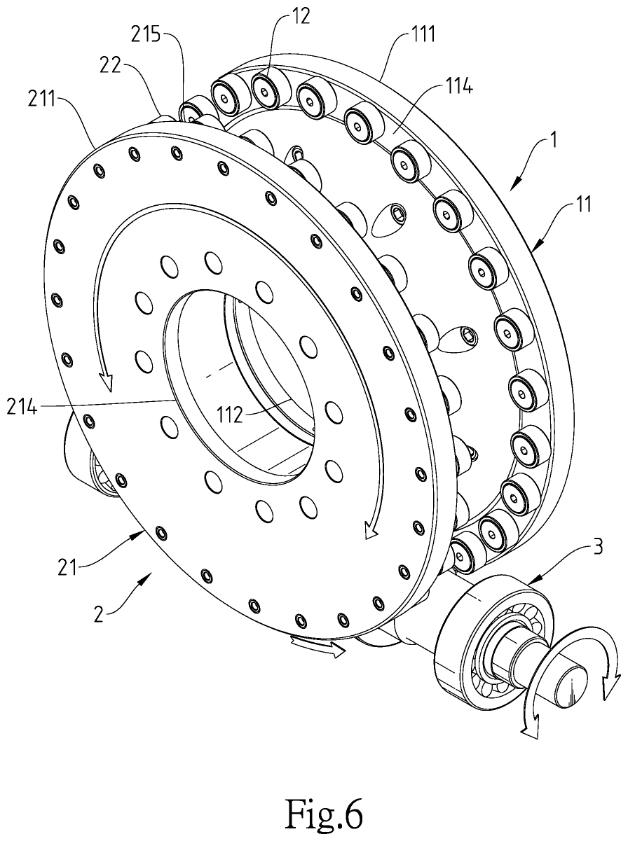

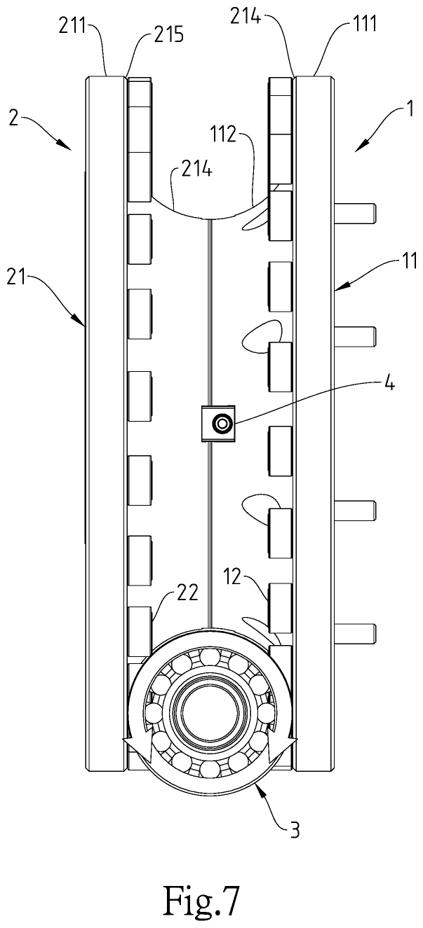

Referring to FIGS. 6 and 7, a backlash-free double row roller cam transmission mechanism in accordance with a third embodiment of the present invention is shown. The same components in the third embodiment and the first embodiment have the same reference numerals, and the same parts will not be repeated. In this third embodiment, the first rotating wheel 11 comprises a first shaft portion 112 protruded from one side thereof. The second rotating wheel 21 comprises a second shaft portion 214 protruded from one side thereof. The first passive wheel 1 corresponds to the second passive wheel 2. A shaft device 4 is used to fasten the first shaft portion 112 and the second shaft portion 214 together. For example, the shaft device 4 can be comprised of a fixing piece and a bolt. The fixing piece is installed between the first shaft portion 112 and the second shaft portion 214, and then the bolt is used to penetrate the fixing piece to lock on the first shaft portion 112 or the second shaft portion 214, so that the first shaft portion 112 and the second shaft portion 214 are connected and fixed. Of course, the type of shaft device 4 used to fix the first shaft portion 112 and the second shaft portion 214 is not limited herein. It is worth noting that there is a gap between the first rollers 12 of the first rotating wheel 11 and the second rollers 22 of the second rotating wheel 21. The first rollers 12 are pivotally connected to a first side edge 114 at the outer edge of the first wheel body 111. The second rollers 22 are pivotally connected to a second side edge 215 at the outer edge of the second wheel body 211. The first wheel body 111 of the first rotating wheel 11 is parallel to the second wheel body 211 of the second rotating wheel 21, making the row of first rollers 12 parallel to the row second rollers 22. The transmission camshaft 3 is located in the distance between the sides of the first passive wheel 1 and the second passive wheel 2, which is the distance between the first shaft portion 112 of the first rotating wheel 11 and the second shaft portion 214 of the second rotating wheel 21, and the diameters of the first shaft portion 112 and the second shaft portion 214 are smaller than the diameters of the first rotating wheel 11 and the second rotating wheel 21. Therefore, the transmission camshaft 3 can be located in the inner side of the first rotating wheel 11 and second rotating wheel 21.

Referring also to FIG. 3, opposing inner surface 311 and outer surface 312 are formed on both sides of the spiral protrusion 31. The inner surface 311 of the spiral protrusion 31 is abutted against the first rollers 12 of the first passive wheel 1. The outer surface 312 of the spiral protrusion 31 is abutted against the second rollers 22 of the second passive wheel 2. When the transmission camshaft 3 is driven, the first passive wheel 1 and the second passive wheel 2 can be relatively pivoted, and the reverse thrust of the first rollers 12 and the second rollers 22 is generated by the principle of oblique wedge adjustment, thereby eliminating the backlash between the first rollers 12 and the inner surface 311 and the backlash between the second rollers 22 and the outer surface 312. In this way, the transmission camshaft 3 can more smoothly and reliably transfer movement and power to the first passive wheel 1 and the second passive wheel 2, and the stable power transmission extends the overall life.

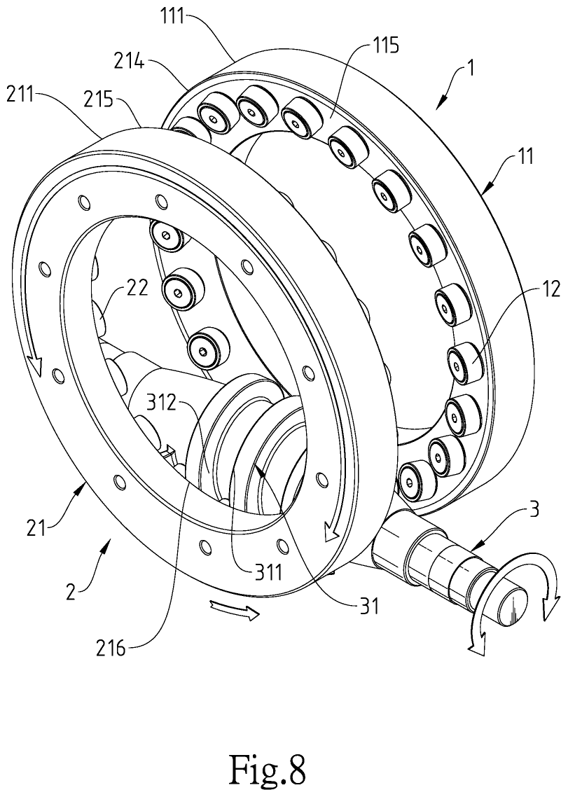

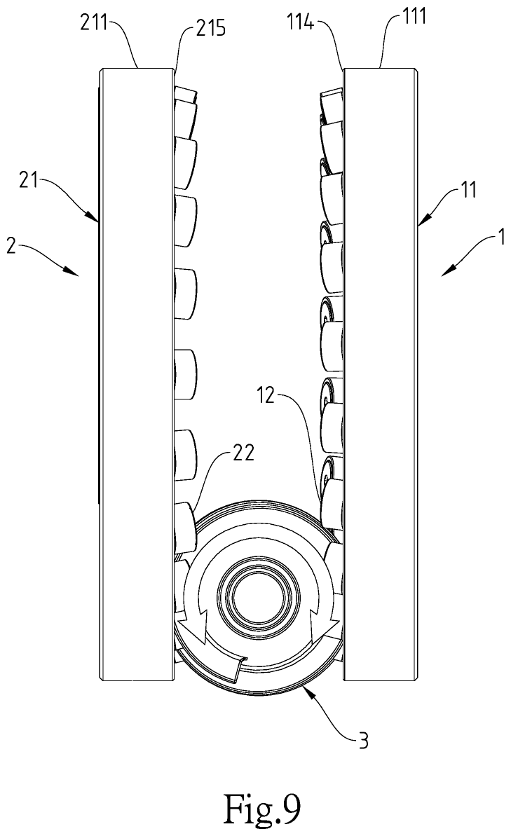

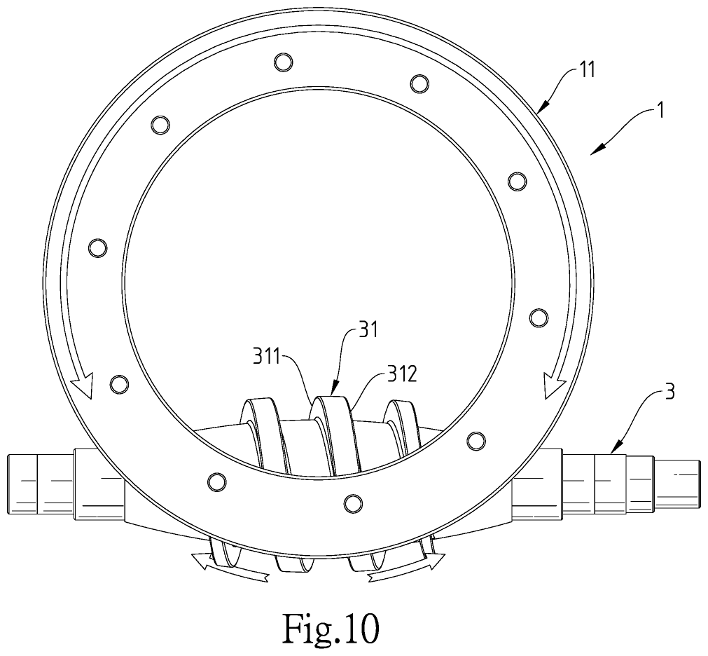

Referring to FIGS. 8-10, a backlash-free double row roller cam transmission mechanism in accordance with a fourth embodiment of the present invention is shown. The same components in the fourth embodiment and the first embodiment have the same reference numerals, and the same parts will not be repeated. In this fourth embodiment, the first rotating wheel 11 of the first passive wheel 1 and the second rotating wheel 21 of the second passive wheel 2 are arranged in parallel. The first wheel body 111 further comprises a first inclined surface 115 located on the first side edge 114. The first rollers 12 are pivotally arranged on the first inclined surface 115. The second wheel body 211 further comprises a second inclined surface 216 located on the second side edge 215. The second rollers 22 are pivotally arranged on the second inclined surface 216. The first inclined surface 115 of the first wheel body 111 is opposite to the second inclined surface 216 of the second wheel body 211. There is a gap between the first rollers 12 of the first rotating wheel 11 and the second rollers 22 of the second rotating wheel 21. The transmission camshaft 3 is located in the gap between the first passive wheel 1 and the second passive wheel 2, that is, the transmission camshaft 3 can be located in the inner side relative to the first rotating wheel 11 and the second rotating wheel 21. Opposing inner surface 311 and outer surface 312 are formed on both sides of the spiral protrusion 31. The inner surface 311 of the spiral protrusion 31 is abutted against the first rollers 12 of the first passive wheel 1. The outer surface 312 of the spiral protrusion 31 is abutted against the second rollers 22 of the second passive wheel 2. When the transmission camshaft 3 is driven, the first passive wheel 1 and the second passive wheel 2 can be relatively pivoted, and the reverse thrust of the first rollers 12 and the second rollers 22 is generated by the principle of oblique wedge adjustment, thereby eliminating the backlash between the first rollers 12 and the inner surface 311 and the backlash between the second rollers 22 and the outer surface 312.

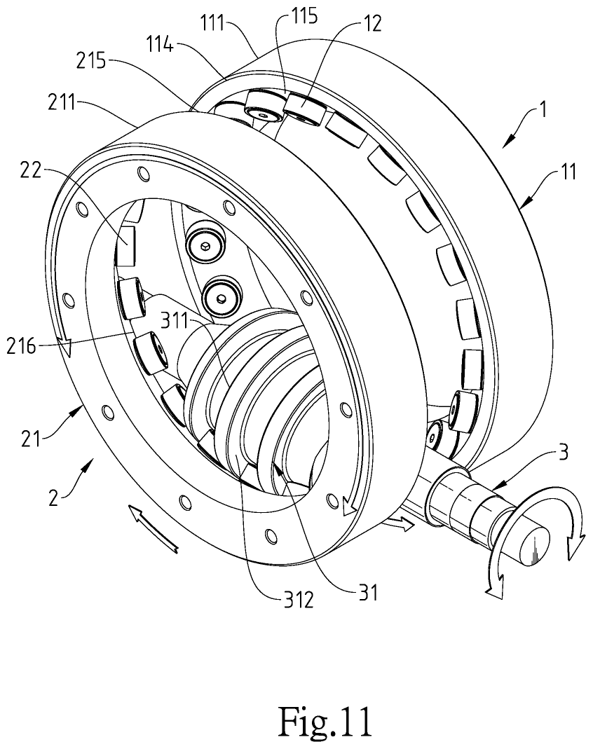

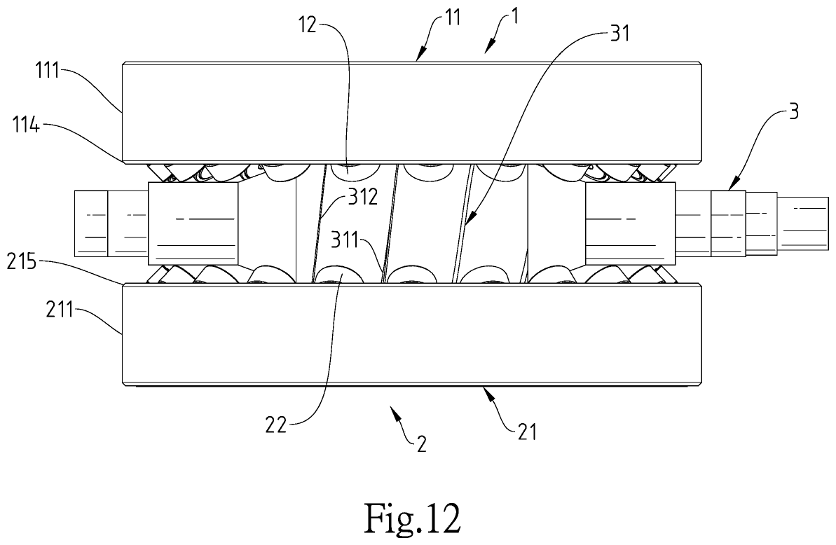

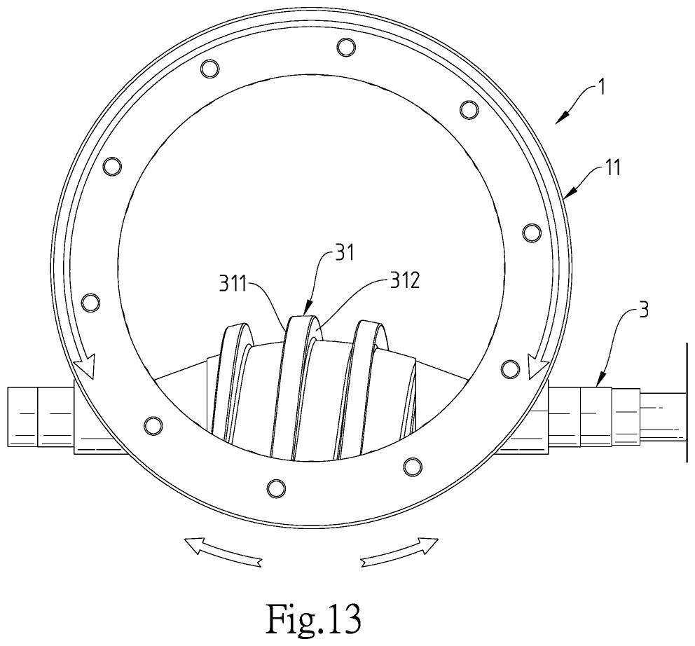

Referring to FIGS. 11-13, a backlash-free double row roller cam transmission mechanism in accordance with a fifth embodiment of the present invention is shown. The same components in the fifth embodiment and the fourth embodiment have the same reference numerals, and the same parts will not be repeated. In this fifth embodiment, the first rotating wheel 11 of the first passive wheel 1 and the second rotating wheel 21 of the second passive wheel 2 are arranged in parallel.

It is worth noting that the inclination angles of the first inclined surface 115 of the first wheel body 111 and the second inclined surface 216 of the second wheel body 211 are larger than that in the aforesaid fourth embodiment. The reason is that the design of the inclination angles of the first inclined surface 115 and the second inclined surface 216 can match the assembly design of transmission camshaft 3. In detail, the first rollers 12 are pivoted on the first inclined surface 115, and the second rollers 22 are pivoted on the second inclined surface 216. When the first inclined surface 115 of the first wheel body 111 is opposite to the second inclined surface 216 of the second wheel body 211, the relative position between the first passive wheel 1, the second passive wheel 2 and the transmission camshaft 3 has more room for adjustment, so that there is gap between the first rollers 12 of wheel 11 and the second rollers 22 of second rotating wheel 21. The transmission camshaft 3 is located in the gap between the sides of the first passive wheel 1 and the second passive wheel 2, that is, the transmission camshaft 3 can be completely located in the inner side relative to the first rotating wheel 11 and the second rotating wheel 21, so as to achieve the most effective saving of overall volume space. Opposing inner surface 311 and outer surface 312 are formed on both sides of the spiral protrusion 31. The inner surface 311 of the spiral protrusion 31 is abutted against the first rollers 12 of the first passive wheel 1. The outer surface 312 of the spiral protrusion 31 is abutted against the second rollers 22 of the second passive wheel 2. When the transmission camshaft 3 is driven, the first passive wheel 1 and the second passive wheel 2 can be relatively pivoted, and the reverse thrust of the first rollers 12 and the second rollers 22 is generated by the principle of oblique wedge adjustment, thereby eliminating the backlash between the first rollers 12 and the inner surface 311 and the backlash between the second rollers 22 and the outer surface 312.

In summary, the present invention uses the first passive wheel 1 and the second passive wheel 2 to share the transmission camshaft 3. The simple structure design ensures that the backlash between the rollers set on the two passive wheels and the spiral protrusion 31 can be eliminated during the transmission process. Regardless of whether the transmission camshaft 3 is driven by clockwise rotation or counterclockwise rotation, it can pivot relatively. Use the principle of oblique wedge adjustment to generate the reverse thrust of the first rollers 12 and the second rollers 22, thereby eliminating the backlash between the first rollers 12 and the inner surface 311 and the backlash between the second rollers 22 and the outer surface 312. It has a variety of application designs to flexibly respond to industry needs, which can not only reduce the inertial load of the spiral protrusion 31, but also increase structural rigidity to prolong service life.

What the invention claimed is:

1. A backlash-free double row roller cam transmission mechanism, comprising:
a first passive wheel comprising a first rotating wheel and a plurality of first rollers, said first rotating wheel comprising a first wheel body providing a circular periphery, said first rollers being pivotally arranged on the circular periphery of said first wheel body away from the center of said first passive wheel;
a second passive wheel comprising a second rotating wheel and a plurality of second rollers, said second rotating wheel comprising a second wheel body providing a circular periphery, said second rollers being pivotally arranged on the circular periphery of said second wheel body away from the center of said second passive wheel; and
a transmission camshaft connected between said first passive wheel and said second passive wheel, said transmission camshaft comprising a spiral protrusion, said spiral protrusion comprising an inner surface and an outer surface respectively located on two opposite sides thereof, said inner surface being abutted against said first rollers of said first passive wheel, said outer surface being abutted against said second rollers of said second passive wheel;
wherein when said transmission camshaft is driven, said first passive wheel and said second passive wheel are relatively pivoted, and the reverse thrust of said first rollers and said second rollers is generated by the principle of oblique wedge adjustment, thereby eliminating the backlash between said first rollers and said inner surface and the backlash between said second rollers and said outer surface.

2. The backlash-free double row roller cam transmission mechanism as claimed in claim 1, wherein said first passive wheel is connected with said second passive wheel; said first rollers are pivotally arranged on a first outer peripheral edge at an outer edge of said first wheel body; said second rollers are pivotally arranged on a second outer peripheral edge at an outer edge of said second wheel body; the section of said first wheel body of said first rotating wheel and the section of said second wheel body of said second rotating wheel are parallel, so that said first rollers and said second rollers are arranged side by side.

3. The backlash-free double row roller cam transmission mechanism as claimed in claim 2, wherein said first rotating wheel comprises a first shaft portion protruded from one side thereof; said second rotating wheel comprises a shaft hole located on one side thereof and pivotally connected to said first shaft portion.

4. The backlash-free double row roller cam transmission mechanism as claimed in claim 1, wherein said first passive wheel is connected with said second passive wheel; said first rollers are pivotally arranged on a first outer peripheral edge at an outer edge of said first wheel body; said second rollers are pivotally arranged on a second outer peripheral edge at an outer edge of said second wheel body; an angle of less than 180 degrees is formed between the section of said first wheel body of said first rotating wheel and the section of said second wheel body of said second rotating wheel, so that said first rollers and said row second rollers are set at an angle of 180 degrees.

5. The backlash-free double row roller cam transmission mechanism as claimed in claim 4, wherein said first rotating wheel comprises a first shaft portion protruded from one side thereof; said second rotating wheel comprises a shaft hole located on one side thereof and pivotally connected to said first shaft portion.

6. The backlash-free double row roller cam transmission mechanism as claimed in claim 1, wherein a gap is formed between said first rollers of said first rotating wheel and said second rollers of said second rotating wheel; said first rollers are pivotally arranged on a first outer peripheral edge at an outer edge of said first wheel body; said second rollers are pivotally arranged on a second outer peripheral edge at an outer edge of said second wheel body; said first wheel body of said first rotating wheel is parallel to said second wheel body of said second rotating wheel; said transmission camshaft is located at one side in said gap between said first passive wheel and said second passive wheel.

7. The backlash-free double row roller cam transmission mechanism as claimed in claim 6, wherein said first rotating wheel comprises a first shaft portion protruded from one side thereof; said second rotating wheel comprises a second shaft portion protruded from one side thereof axially connected to said first shaft portion with a shaft device.

8. The backlash-free double row roller cam transmission mechanism as claimed in claim 1, wherein said first wheel body comprises a first side edge located at an outer side thereof, and a first inclined surface located on said first side edge; said first rollers are pivotally arranged on said first inclined surface; said second wheel body comprises a second side edge located at an outer side thereof, and a second inclined surface located on said second side edge opposite to said first inclined surface; said second rollers are pivotally arranged on said second inclined surface; a gap is formed between said first rollers of said first rotating wheel and said second rollers of said second rotating wheel; said transmission camshaft is located at one side in said gap between said first passive wheel and said second passive wheel.
